(19) United States
(12) Patent Application Publication
(10) Pub. No.: US 2026/0188801 A1
(43) Pub. Date: Jul. 2, 2026

(54) SEALING MATERIAL FOR LITHIUM SECONDARY BATTERY, MANUFACTURING METHOD THEREOF, AND POUCH CELL FOR LITHIUM SECONDARY BATTERY CONTAINING THE SAME

(71) Applicant: SK On Co., Ltd., Seoul (KR)

(72) Inventors: Dong Heum PARK, Daejeon (KR); Ju Young CHOI, Daejeon (KR); Min Kyung BAEK, Daejeon (KR); Kyung Suk SUK, Daejeon (KR); Ik Suk LEE, Daejeon (KR); Jae Woong CHO, Daejeon (KR)

(21) Appl. No.: 19/428,336

(22) Filed: Dec. 22, 2025

(30) Foreign Application Priority Data
Dec. 31, 2024 (KR) 10-2024-0201629

(51) Int. Cl. H01M 50/129; B23K 26/362; B32B 7/12; B32B 15/085; C09J 5/00; H01M 50/105; H01M 50/119; H01M 50/121

(52) U.S. Cl. CPC H01M 50/129; B23K 26/362; B32B 7/12; B32B 15/085; C09J 5/00; H01M 50/105; H01M 50/119; H01M 50/121; B32B 2255/10; B32B 2307/73; B32B 2457/10; C09J 2203/33; C09J 2400/166; C09J 2423/108; C09J 2477/008

(57) ABSTRACT

A sealing material for a lithium secondary battery of the present disclosure includes an internal resin layer including a polymer resin; a metal thin film layer provided on an upper surface of the internal resin layer; an external resin layer provided on an upper surface of the metal thin film layer; a film layer provided on an upper surface of the external resin layer; and a water-repellent treatment layer provided on a lower surface of the internal resin layer.

### CROSS-REFERENCE TO RELATED APPLICATION(S)

This patent document claims the priority and benefits of Korean Patent Application No. 10-2024-0201629 filed on Dec. 31, 2024, the disclosure of which is incorporated herein by reference in its entirety.

### TECHNICAL FIELD

The disclosure and implementations disclosed in this patent document generally relate to a sealing material for a lithium secondary battery, a method for manufacturing the same, and a pouch cell for a lithium secondary battery including the same.

### BACKGROUND

Battery cells may be secondary batteries installed in vehicles or the like, and, unlike primary batteries, secondary batteries may charge and discharge electricity and may be applied to a wide range of applications in devices such as a digital camera, a mobile phone, a laptop, and a hybrid vehicle. Examples of the secondary batteries may include a nickel-cadmium battery, a nickel-metal hydride battery, a nickel-hydrogen battery, a lithium secondary battery, or the like.

Depending on a shape of an outer packaging material, the secondary batteries may be classified into a can-type secondary battery in which an electrode assembly is housed in a metal can, and a pouch-type secondary battery in which an electrode assembly is housed in a pouch such as an aluminum laminate sheet.

Thereamong, the pouch-type secondary battery may be manufactured by housing an electrode assembly in an outer packaging material having a pouch type, injecting an electrolyte solution, and sealing an inlet. Conventional manufacturing methods may have problems of occurring cracks in a pouch during a process of sealing the pouch, which may lower insulation resistance upon contact with the electrolyte solution, leading to insulation failure in the secondary battery and formation of parasitic capacitance.

### SUMMARY

According to an aspect of the present disclosure, a sealing material for a lithium secondary battery, a method for manufacturing the same, and a pouch cell for a lithium secondary battery including the same, capable of suppressing an insulation failure problem, may be provided.

According to an aspect of the present disclosure, a sealing material for a lithium secondary battery, a method for manufacturing the same, and a pouch cell for a lithium secondary battery including the same, capable of suppressing formation of parasitic capacitance, may be provided.

According to an aspect of the present disclosure, a sealing material for a lithium secondary battery of the present disclosure includes an internal resin layer including a polymer resin; a metal thin film layer provided on an upper surface of the internal resin layer; an external resin layer provided on an upper surface of the metal thin film layer; a film layer provided on an upper surface of the external resin layer; and a water-repellent treatment layer provided on a lower surface of the internal resin layer.

The water-repellent treatment layer may be provided on at least one region of the lower surface of the internal resin layer, wherein the one region may be a region in which portions of the sealing material are fused to each other, when the sealing material is folded so that the water-repellent treatment layer is in contact with each other.

The water-repellent treatment layer may be provided in a region in which portions of the sealing material are fused to each other, and a surrounding region thereof.

The water-repellent treatment layer may be formed by chemical treatment or physical treatment.

The polymer resin may be at least one selected from the group consisting of a polypropylene-based polymer resin, a polyethylene-based polymer resin, and a copolymer thereof.

The metal thin film layer may include aluminum (Al), copper (Cu), iron (Fe), carbon (C), chromium (Cr), manganese (Mn), nickel (Ni), or an alloy of at least two or more thereof.

The sealing material for a lithium secondary battery may further include a first adhesive layer provided between the metal thin film layer and the external resin layer, and a second adhesive layer provided between the external resin layer and the film layer.

A pouch cell for a lithium secondary battery according to an aspect of the present disclosure may be a pouch cell in which an electrode assembly in which a positive electrode, a negative electrode, and a separator interposed between the positive and negative electrodes are assembled is housed in a pouch sealed with the sealing material such that the water-repellent treatment layer is in contact with each other.

A method for manufacturing a sealing material for a lithium secondary battery, according to an aspect of the present disclosure, includes stacking an internal resin layer including a polymer resin, a metal thin film layer provided on an upper surface of the internal resin layer, an external resin layer provided on an upper surface of the metal thin film layer, and a film layer provided on an upper surface of the external resin layer, and forming a water-repellent treatment layer provided on a lower surface of the internal resin layer, wherein the water-repellent treatment layer is formed by chemical treatment or physical treatment.

The water-repellent treatment layer may be provided on at least one region of the lower surface of the internal resin layer, and wherein the one region may be formed by chemical treatment or physical treatment for a region in which portions of the sealing material are fused to each other, or a region in which portions of the sealing material are fused to each other, and a surrounding region thereof, when the sealing material is folded so that the water-repellent treatment layer is in contact with each other.

The chemical treatment may include applying and drying a composition for forming the water-repellent treatment layer.

The physical treatment may include forming an etching structure on the lower surface of the internal resin layer at a depth having a micrometer unit level to a nanometer unit level using plasma treatment or laser treatment.

### BRIEF DESCRIPTION OF DRAWINGS

Certain aspects, features, and advantages of the present disclosure may be illustrated by the following detailed description with reference to the accompanying drawings.

FIG. 1 schematically illustrates a structure of a sealing material for a lithium secondary battery according to an embodiment of the present disclosure.

FIG. 2 schematically illustrates a structure of a sealing material for a lithium secondary battery according to an embodiment of the present disclosure, wherein a water-repellent treatment layer (hatched region) is formed on a portion of a lower surface of an internal resin layer along an outer perimeter.

FIG. 3 schematically illustrates a structure of a sealing material for a lithium secondary battery according to an embodiment of the present disclosure, wherein a water-repellent treatment layer (hatched region) is formed entirely on a lower surface of an internal resin layer along an outer perimeter.

FIG. 4 schematically illustrates a method of (1) Current Test of the present disclosure.

FIG. 5 schematically illustrates a process in which an electrolyte solution is vaporized to cause insulation breakdown in a region in which a sealing material is fused to each other.

FIG. 6 schematically illustrates a method of (2) Tensile Test of the present disclosure.

FIGS. 7 and 8 schematically illustrate a method of (3) Evaluation of Insulation Property according to Formation of Water-Repellent Treatment Layer of the present disclosure.

FIG. 9 illustrates an SEM image of a cross-section of a sample pouch of Comparative Example 1 in which no insulation breakdown occurred.

FIGS. 10A to 10C illustrate SEM images of cross-sections of a sample pouch of Comparative Example 1 in which insulation breakdown occurred, taken at 250×, 1200×, and 2500× magnification.

FIGS. 11A and 11B illustrate SEM images of cross-sections of a sample pouch of Inventive Example 1 having excellent insulation resistance, taken at 300× and 2500× magnification.

### DETAILED DESCRIPTION

The present disclosure will be described in detail below. However, this is merely illustrative, and the present disclosure is not limited to the specific embodiments described as examples.

The terminology used in this application may be solely for the purpose of describing specific embodiments, and may not be intended to limit the present disclosure. Singular expressions include plural expressions unless the context clearly dictates otherwise. In this application, terms such as “comprise,” “include,” “have,” or the like indicate the presence of a feature, a numeral, a step, an operation, a component, a part, or combination thereof described in the specification, but should be understood as not excluding possibility of the presence or addition of one or more other features, numbers, steps, operations, components, parts, or combinations thereof.

Unless otherwise defined, all terms used herein, including technical or scientific terms, have the same meaning as commonly understood by one of ordinary skill in the art to which the present disclosure pertains. Terms defined in commonly used dictionaries should be interpreted as having a meaning consistent with their meaning in the context of the relevant technology, and shall not be construed as idealistic or overly formal unless explicitly defined herein.

Hereinafter, preferred embodiments of the present disclosure will be described in more detail with reference to the accompanying drawings.

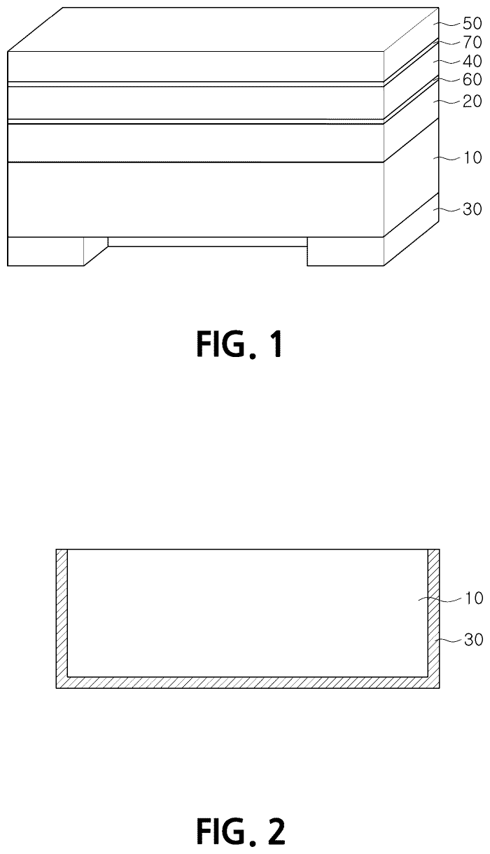

Referring to FIG. 1, a sealing material for a lithium secondary battery of the present disclosure may include an internal resin layer including a polymer resin; a metal thin film layer provided on an upper surface of the internal resin layer; an external resin layer provided on an upper surface of the metal thin film layer; a film layer provided on an upper surface of the external resin layer; and a water-repellent treatment layer provided on a lower surface of the internal resin layer. Specifically, the sealing material may have a structure in which the water-repellent treatment layer, the internal resin layer, the metal thin film layer, the external resin layer, and the film layer are stacked in sequence.

In the present disclosure, the terms “upper surface” and “lower surface” can be understood to be terms used to distinguish one surface and the other surface of a single layer, and thus, the upper surface and the lower surface may be used interchangeably depending on an arrangement direction.

An internal resin layer 10 may be in direct contact with an electrolyte solution of the lithium secondary battery, and, thus, should have electrolyte resistance, should also maintain an insulation property to prevent current flow inside or outside the sealing material even when contacting with the electrolyte solution, and should also possess a waterproof property to block external moisture. Additionally, the internal resin layer is preferred to have heat resistance that may withstand high temperatures.

The internal resin layer may include a polymer resin, and the polymer resin may be at least one selected from the group consisting of a polypropylene-based polymer resin, a polyethylene-based polymer resin, and a copolymer thereof. For example, the polypropylene-based polymer resin may include, but is not limited to, a polypropylene polymer, a propylene/ethylene random copolymer, a propylene/ethylene block copolymer, an acid-modified polypropylene (PPa) polymer, an ethylene/propylene/α-olefin terpolymer, or the like. In addition, the polyethylene-based polymer resin may include, but is not limited to, a polyethylene copolymer including an ethylene vinyl acetate copolymer (EVA), an acrylic acid-ethylene copolymer (EAA), a methacrylic acid-ethylene copolymer (EMAA), an ethyl acrylate-ethylene copolymer (EEA), a methyl acrylate-ethylene copolymer (EMA), or a methyl methacrylate-ethylene copolymer (EMMA).

The internal resin layer should be able to fuse with the sealing material by an external heat source during a process of manufacturing the pouch. Therefore, the polymer resin included in the internal resin layer that may be at least partially melted by the external heat source and thus possesses formability and heat-sealing properties may be used.

The internal resin layer may have a thickness, but is not limited to, of approximately 10 to 200 μm, specifically approximately 20 to 150 μm, and more specifically approximately 50 to 100 μm. When the thickness of the internal resin layer is less than 10 μm, the electrolyte solution may be lost or cracks may easily occur during the process of manufacturing the pouch. When the thickness of the internal resin layer is greater than 200 μm, excessive heat source may be required for fusion between the internal resin layers, or a fusion failure problem may occur.

A metal thin film layer 20 may impart mechanical strength to the sealing material or pouch, while also ensuring flexibility and protecting an electrode assembly housed in the sealing material or pouch from the external moisture. The metal thin film layer may include aluminum (Al), copper (Cu), iron (Fe), carbon (C), chromium (Cr), manganese (Mn), nickel (Ni), or an alloy of at least two or more thereof.

A thickness of the metal thin film layer may range, but is not limited to, from about 10 to 100 μm, specifically from about 20 to 80 μm, and more specifically from about 30 to 60 μm. When the thickness of the metal thin film layer is less than 10 μm, problems with internal penetration of gas and moisture may occur. When the thickness of the metal thin film layer is greater than 100 μm, problems with physical damage due to inadequate securing of mechanical strength may occur.

A water-repellent treatment layer 30 may prevent a vaporized electrolyte solution from combining with the internal resin layer to form pores or cracks in the internal resin layer, even when the vaporized electrolyte solution is generated during a sealing process.

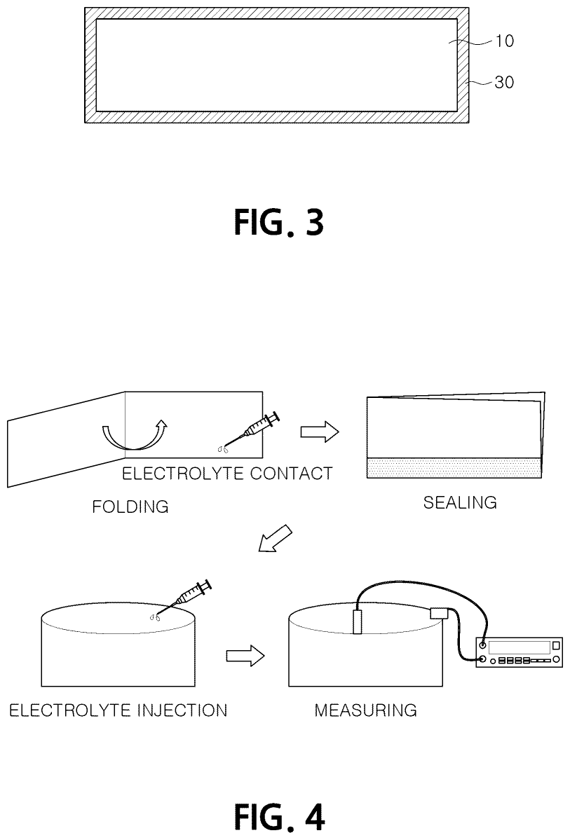

Referring to FIGS. 2 and 3, a water-repellent treatment layer may be provided on all or a portion of a lower surface of an internal resin layer, and specifically, may be provided on a region in which a sealing material is fused to each other by an external heat source to form a pouch shape. Alternatively, a water-repellent treatment layer may be provided on a region in which a sealing material is fused to each other, and a surrounding region thereof. The region in which portions of the sealing material are fused to each other may be located on all or a portion of an outer periphery of the sealing material, and the region in which the sealing material is fused may have a width of about 5 mm to about 20 mm along the outer periphery of the sealing material, and may be provided with a width of about 10 mm, for example. A surrounding region of the region in which the sealing material is fused may mean a region adjacent to the region in which the sealing material is fused on the lower surface of the internal resin layer, and may be formed in the same shape as the region in which the sealing material is fused. Although not limited thereto, the surrounding region of the region in which the sealing material is fused may be provided around a periphery of the region in which the sealing material is fused, with a width of 1% or more, 3% or more, 5% or more, 10% or more, 15% or more, or 20% or more, but 100% or less, 80% or less, 60% or less, or 50% or less of the width of the region in which the sealing material is fused. A width or an area of the region in which the sealing material is fused and the surrounding region thereof may be appropriately changed depending on the sealing material, or an electrode assembly housed in a pouch.

A thickness of the water-repellent treatment layer may be, but is not limited to, about 10 to 1000 nm, more specifically, about 20 to 800 nm. When the thickness of the water-repellent treatment layer is less than 10 nm, a problem of reducing an insulation effect may occur, and when the thickness of the water-repellent treatment layer is greater than 800 nm, a problem of uneven thickness may occur.

The water-repellent treatment layer may utilize any known water-repellent treatment method, and may be formed through chemical or physical treatment.

An external resin layer 40 may be configured to supplement an insulation property of the sealing material or pouch, and provide flexibility to the sealing material or pouch. The external resin layer may include, but is not limited to, a nylon, a polyester-based resin, a polyamide-based resin, a polyimide-based resin, or the like. A thickness of the external resin layer may range from about 1 to 50 μm, specifically from about 5 to 30 μm, and more specifically from about 10 to 20 μm, but is not limited thereto. When the thickness of the external resin layer is less than 1 μm, cracks may easily occur during the process of manufacturing the pouch. When the thickness of the external resin layer is greater than 50 μm, a problem of overall pouch thickness variation may be generated.

A film layer 50 may protect the electrode assembly housed in the sealing material or pouch from external moisture or the like, and may be located on an outermost surface of the pouch to provide surface rigidity. The film layer may be often formed of polyethylene terephthalate (PET), but is not limited thereto. A thickness of the film layer may be, but is not limited to, about 1 to 50 μm, specifically about 5 to 30 μm, and more specifically about 10 to 20 μm. When the thickness of the film layer is less than 1 μm, a problem of durability degradation may occur, and when the thickness of the film layer is greater than 50 μm, a problem of overall pouch thickness variation may occur.

Referring to FIG. 1, a sealing material for a lithium secondary battery according to an embodiment of the present disclosure may further include a first adhesive layer provided between the metal thin film layer and the external resin layer, and a second adhesive layer provided between the external resin layer and the film layer. For example, the sealing material may have a structure in which the water-repellent treatment layer, the internal resin layer, the metal film layer, the first adhesive layer, the external resin layer, the second adhesive layer, and the film layer are stacked in sequence.

A first adhesive layer 60 may be provided to ensure adhesion between the metal film layer and the external resin layer, and may also enhance insulation of the sealing material or pouch. The first adhesive layer may include one or more selected from the group consisting of polyol, isocyanate, and polyurethane.

A thickness of the first adhesive layer may be approximately 2 to 10 μm. When the thickness of the first adhesive layer is less than 2 μm, a problem of weakening adhesive strength may be generated, and when the thickness of the first adhesive layer is greater than 10 μm, a cracking problem may occur.

A second adhesive layer 70 may be provided to ensure adhesion between the external resin layer and the film layer, may also protect the sealing material or pouch from penetration of external moisture, and may also enhance heat resistance to withstand high external temperatures. The second adhesive layer may include at least one selected from the group consisting of polyol, isocyanate, and polyurethane.

A thickness of the second adhesive layer may be about 2 to 10 μm. When the thickness of the second adhesive layer is less than 2 μm, a problem of weakening adhesive strength may be generated, and when the thickness of the second adhesive layer is greater than 10 μm, a cracking problem may occur.

A method for manufacturing a sealing material for a lithium secondary battery, according to another embodiment of the present disclosure, may include stacking an internal resin layer including a polymer resin, a metal thin film layer provided on an upper surface of the internal resin layer, an external resin layer provided on an upper surface of the metal thin film layer, and a film layer provided on an upper surface of the external resin layer, and forming a water-repellent treatment layer provided on a lower surface of the internal resin layer, wherein the water-repellent treatment layer is formed by chemical treatment or physical treatment.

The water-repellent treatment layer may be provided on at least one region of the lower surface of the internal resin layer, and wherein the one region may be formed by chemical treatment or physical treatment for a region in which portions of the sealing material are fused to each other, or a region in which portions of the sealing material are fused to each other, and a surrounding region thereof, when the sealing material is folded so that the water-repellent treatment layer is in contact with each other.

The chemical treatment may include applying and drying a composition for forming the water-repellent treatment layer to a region in which the water-repellent treatment layer is to be formed on the lower surface of the internal resin layer and drying the same. For example, the composition may be applied once or multiple times to a region in which portions of the sealing material are fused to each other, or the region in which portions of the sealing material are fused to each other, and a surrounding region thereof, and dried at about 15 to 30° C. for about 5 to 300 seconds to form the water-repellent treatment layer. Alternatively, the composition may be applied once to a region in which portions of the sealing material are fused to each other, or a region in which portions of the sealing material are fused to each other, and a surrounding region thereof, and then dried at about 15 to 30° C. for about 5 to 300 seconds, and repeated once or multiple times to form the water-repellent treatment layer.

The composition for forming a water-repellent treatment layer may be a composition including a compound including at least one element of fluorine or silicon. The compound including at least one element of fluorine or silicon may be at least one selected from the group consisting of polytetrafluoroethylene (PTFE), 1H, 1H, 2H, 2H-perfluorodecyltriethoxysilane (PFDTES), polydimethylsiloxane (PDMS), octadecyltrichlorosilane (OTS), polymethylhydrosiloxane (PMHS), and silicon dioxide, and may be, for example, silicon dioxide. The exemplified compounds may have very low surface energy, and may have thus low affinity with liquids, making it difficult for the electrolyte solution to penetrate toward the internal resin layer. In addition to the compound including at least one element of fluorine or silicon, the composition may further include a solvent, a fluororesin, a silicone resin, or the like. Additionally, the composition may further include additives such as a crosslinking agent, an organic acid stabilizer, an ultraviolet-resistant additive, and the like, as needed.

The physical treatment may include forming an etching structure on the lower surface of the internal resin layer at a depth having a micrometer unit level to a nanometer unit level using plasma treatment, laser treatment, or the like, and more specifically, to form an etched structure with a depth having a micrometer unit level to a nanometer unit level on the lower surface of the internal resin layer through plasma treatment or laser treatment. By forming the micro- or nano-structures, a water-repellent treatment layer that imparts water repellency to the lower surface of the internal resin layer may be formed.

The plasma treatment or the laser treatment may be a method of irradiating plasma or laser to a region on the lower surface of the internal resin layer in which the water-repellent treatment layer is desired.

The plasma treatment may include, but is not limited to, atmospheric pressure plasma treatment, plasma exposure to increase a contact angle of the lower surface of the internal resin layer through multiple exposures to plasma, plasma etching to etch a surface of the lower surface of the internal resin layer, a method of binding hydrophobic molecules including fluorine groups or the like to the lower surface of the internal resin layer after the plasma etching, or the like.

The laser treatment may include, but is not limited to, laser etching to etch a surface of the lower surface of the internal resin layer using a laser, a method of lowering surface energy of the lower surface of the internal resin layer using a laser, or the like.

A sealing material for a lithium secondary battery of the present disclosure may be manufactured by stacking a metal thin film layer on an upper surface of an internal resin layer, forming a first adhesive layer on an upper surface of the metal thin film layer, stacking an external resin layer, forming a second adhesive layer on an upper surface of the external resin layer, stacking a film layer, and forming a water-repellent treatment layer on a lower surface of the internal resin layer. In this case, the water-repellent treatment layer may be formed using the method described above.

A pouch for a lithium secondary battery according to another embodiment of the present disclosure may be manufactured by sealing a sealing material for a lithium secondary battery such that a water-repellent treatment layer is in contact with each other.

A pouch cell for a lithium secondary battery according to the present disclosure may be manufactured by sealing a sealing material such that a water-repellent treatment layer is in contact with each other, housing an electrode assembly therein, injecting an electrolyte solution, and completely sealing the sealing material in an inlet portion through which the electrolyte solution is injected. In this case, a degassing process, which discharges gas formed in a pouch after injecting the electrolyte solution into the pouch and before the complete sealing, may be performed. During the degassing process, a portion of the electrolyte solution may be in contact with an opened portion of the pouch. In this case, the contacted electrolyte solution may vaporize in the completely sealed pouch, to have a problem of damaging an insulation property. A pouch of the present disclosure may form the water-repellent treatment layer on the lower surface of the internal resin layer, even when the electrolyte solution is in contact with a region in which portions of the sealing material are fused to each other in the pouch during the degassing process, to suppress vaporizing the electrolyte solution during the complete sealing process to couple the vaporized electrolyte solution and the internal resin layer to form pores, or to suppress causing of cracks in the internal resin layer, thereby preventing destruction of an insulation property of the pouch.

Although not specifically described in the present disclosure, any known process necessary for manufacturing a pouch-type lithium secondary battery may be performed as needed. Furthermore, any material that may be manufactured in a pouch form may be housed in a pouch for a lithium secondary battery of the present disclosure. A detailed description of the lithium secondary battery will be omitted.

Referring to FIG. 2, a water-repellent treatment layer may be formed along an outer perimeter on which a sealing material is sealed, and the water-repellent treatment layer may be formed along three of four external sides of the sealing material, excluding any one side. In this case, a pouch may be folded in half with one side, without a water-repellent treatment layer formed as a lower side, and the sealing material may be sealed such that the water-repellent treatment layer is in contact with each other, except for a side in which the water-repellent treatment layer is formed, and an electrode assembly may be stored in the pouch through an unsealed portion.

Referring to FIG. 3, a water-repellent treatment layer may be formed entirely along an outer perimeter on which a sealing material is sealed. In this case, the sealing material may be folded in half, a portion of the sealing material may be sealed, and after an electrode assembly is stored in a pouch and an electrolyte solution is injected, a portion forming an inlet through which the electrolyte solution is injected may be completely sealed, and an insulation failure problem may be suppressed even in the portion forming an inlet through which the electrolyte solution is injected.

According to another embodiment of the present disclosure, a pouch cell for a lithium secondary battery may be configured that an electrode assembly in which a positive electrode, a negative electrode, and a separator interposed between the positive and negative electrodes are assembled is housed in a pouch sealed with the sealing material such that the water-repellent treatment layer is in contact with each other.

According to another embodiment of the present disclosure, a pouch for a lithium secondary battery may be manufactured by partially sealing edges of a sealing material in which an internal resin layer, a metal thin film layer, a first adhesive layer, an external resin layer, a second adhesive layer, and a film layer are stacked in sequence, and forming a water-repellent treatment layer along a periphery of a sealed region (the region in which the sealing material is fused) through the chemical treatment or the physical treatment, such as plasma treatment, laser treatment, or the like, described above.

### EXAMPLES

Hereinafter, embodiments of the present disclosure will be further described with reference to specific experimental examples. Inventive Examples and Comparative Examples included in the experimental examples are intended to illustrate the present disclosure and do not limit the scope of the appended claims. It will be apparent to those skilled in the art that various modifications and variations of embodiments are possible in the scope and technical spirit of the present disclosure. It can be also understood that such modifications and variations fall in the scope of the appended claims.

### Inventive Example 1

A polypropylene polymer was used to form an 80 μm internal resin layer, a 40 μm aluminum metal film layer, a 2˜3 μm first adhesive layer, a 15 μm nylon external resin layer, a 2˜3 μm second adhesive layer, and a 12 μm PET film layer were stacked on an upper surface of the internal resin layer, and a water-repellent treatment layer having a width of approximately 10 mm and a thickness of approximately 500 nm was formed along an outer perimeter of a lower surface of the internal resin layer, to produce a sealing material having the form illustrated in FIG. 2. The water-repellent treatment layer was formed by applying a composition for forming a water-repellent treatment layer including at least 15 mass % of polymethylhydrosiloxane once to the lower surface of the internal resin layer, and drying the same at approximately 25° C. for approximately 60 seconds.

### Inventive Example 2

A sealing material was produced in the same manner as in Inventive Example 1, but with a water-repellent treatment layer formed in the form illustrated in FIG. 3.

### Inventive Example 3

A polypropylene polymer was used to form an 80 μm internal resin layer, a 40 μm aluminum metal film layer, a 2˜3 μm first adhesive layer, a 15 μm nylon external resin layer, a 2˜3 μm second adhesive layer, and a 12 μm PET film layer were stacked on an upper surface of the internal resin layer, and a water-repellent treatment layer having a width of approximately 10 mm was formed along an outer perimeter of a lower surface of the internal resin layer, to produce a sealing material having the form illustrated in FIG. 2. Plasma was irradiated to the lower surface of the internal resin layer to form a water-repellent treatment layer such that an etching structure of a micrometer unit level was included.

### Comparative Example 1

Comparative Example 1 was manufactured in the same manner as Inventive Example 1, but without forming a water-repellent treatment layer.

### (1) Current Test

As illustrated in FIG. 4, a sealing material of Comparative Example 1 was folded in half, a region in which the sealing material was fused was in contact with an electrolyte solution, sealed, and then the electrolyte solution was injected to produce 20 sample pouches. The electrolyte solution used herein included approximately 12 wt % LiPF₆ as a lithium salt and an approximately 5:2 weight ratio of ethyl methyl carbonate (EMC) and ethylene carbonate (EC) as solvents. Terminals of an insulation resistance tester were connected to the electrolyte solution and metal film layers on cross-sections of the pouches, respectively, to measure insulation resistance. Results therefrom were listed in Electrolyte solution Contact section of Comparative Example 1 in Table 1. The insulation resistance was measured under conditions of a voltage of 50 V, a test time of 1 second, and a voltage rise time (delay) of 0.3 seconds.

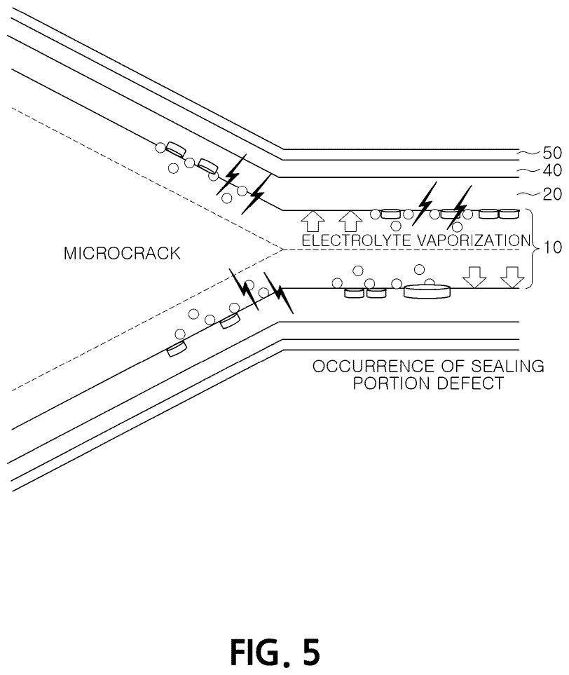

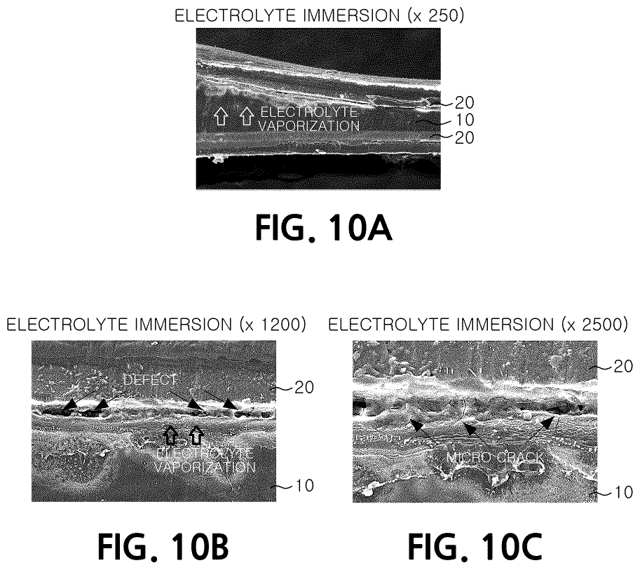

Furthermore, cross-sections of sample pouches in which insulation resistance breakdown occurred were photographed using an SEM, and results therefrom were illustrated in FIGS. 5 and 10A to 10C. The cross-sections of sample pouches that exhibited insulation resistance breakdown were milled using Ar ions under conditions of an acceleration voltage of 4.5 kV, a discharge voltage of 1.1 kV, and a milling time of 4 hours before the SEM photographing.

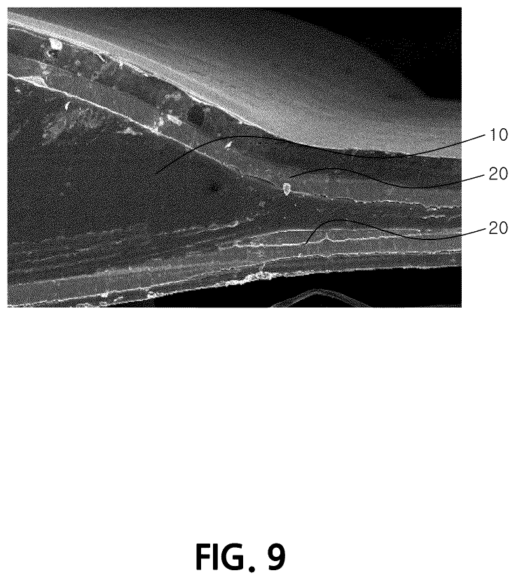

Furthermore, the region in which the sealing material of Comparative Example 1 was fused was not exposed to the electrolyte solution. As illustrated in FIG. 4, 20 sample pouches were manufactured. The insulation resistance was measured similarly, and results therefrom were listed in Electrolyte Non-Contact section of Comparative Example 1 in Table 1. Furthermore, cross-sections of sample pouches having excellent insulation resistance were subjected to Ar ion milling as described above and photographed using SEM, and results therefrom were illustrated in FIG. 9.

TABLE 1

| | | |
|---|---|---|
| | Electrolyte Contact of | Electrolyte Non-Contact |
| Sample | Comparative Example 1 | of Comparative Example 1 |

| | |
|---|---|
| No. | Insulation Resistance [MΩ] |

| | | |
|---|---|---|
| 1 | 1.68 | 5000 |
| 2 | 15.4 | 5000 |
| 3 | 5000 | 5000 |
| 4 | 3.38 | 5000 |
| 5 | 3.1 | 5000 |
| 6 | 1.41 | 3340 |
| 7 | 4.96 | 5000 |
| 8 | 2.16 | 5000 |
| 9 | 3.46 | 5000 |
| 10 | 3854 | 5000 |
| 11 | 5.36 | 5000 |
| 12 | 3.43 | 5000 |
| 13 | 12.9 | 5000 |
| 14 | 7.48 | 5000 |
| 15 | 12 | 5000 |
| 16 | 3.11 | 5000 |
| 17 | 1.77 | 5000 |
| 18 | 8.77 | 5000 |
| 19 | 257 | 5000 |
| 20 | 1354 | 5000 |

Except for one sample pouch that did not contact the electrolyte solution in the fused region, insulation resistances of approximately 5,000 MΩ were measured. Conversely, all sample pouches, except for the one sample pouch, contacted with the electrolyte solution in the fused region, exhibited an insulation breakdown phenomenon.

Therefrom, it may be expected that insulation breakdown may easily occur when the electrolyte solution is in contact with the fused region of the sealing material. Specifically, during a degassing process, the electrolyte solution may be in contact with an unsealed portion of the sealing material. During a sealing process, the electrolyte solution may be vaporized, and the vaporized electrolyte solution may be coupled to a polymer resin of an internal resin layer to form pores. These pores may cause cracks in the internal resin layer, leading to insulation breakdown, as schematically illustrated in FIG. 5.

FIG. 9 illustrates an SEM image of a cross-section of a sample pouch having excellent insulation resistance among sample pouches without electrolyte solution contact, taken at 250× magnification. No defects were observed between the internal resin layer and the metal film layer.

FIGS. 10A to 10 10C illustrate SEM images of cross-sections of sample pouches, among sample pouches with electrolyte solution contact, in which insulation breakdown occurred, taken at 250×, 1200×, and 2500×. Traces in which an electrolyte solution was vaporized were observed, confirming formation of microcracks between an internal resin layer and a metal film layer, resulting in pouch defects. It was found that electrolyte solution vaporization in a fused region may cause insulation breakdown.

### (2) Tensile Test

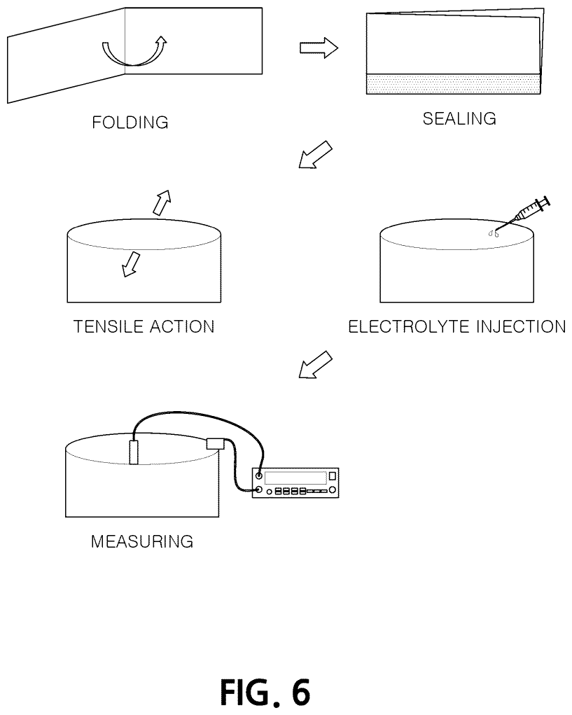

As illustrated in FIG. 6, the sealing material of Comparative Example 1 was folded in half and sealed, and a Universal Testing Machine (UTM) was used to pull the pouch in both directions at two opposing points around an inlet through the electrolyte solution was injected, with forces of 500 N, 50 N, and 5 N, respectively. The electrolyte solution was then injected to produce three sample pouches. The electrolyte solution used was the same as in (1) above, and an insulation resistance measurement method was also the same as in (1). Measured insulation resistances were illustrated in Table 2.

TABLE 2

| | Insulation |
|---|---|
| | Resistance [MΩ] |
| Sample | of Comparative |
| No. | Example 1 |
| 1 | 92.4 |
| 2 | 5000 |
| 3 | 5000 |

Force applied to sample pouches may correspond to force exerted on the pouches by gas (including vaporized electrolyte solution) emitted during a degassing operation during a process of manufacturing the pouches. Sample pouch 1, which was subjected to the maximum force, exhibited insulation breakdown. However, since force applied to Sample pouch 1 was generally greater than pressure caused by the gas emitted during the degassing operation, it was confirmed that possibility of damage to an internal resin layer due to pressure generated by an electrolyte solution to be vaporized after sealing was low.

### (3) Evaluation of Insulation Property According to Formation of Water-Repellent Treatment Layer

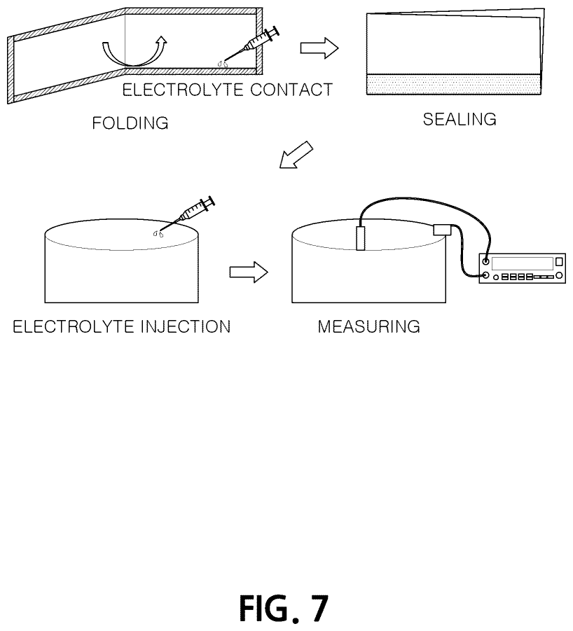

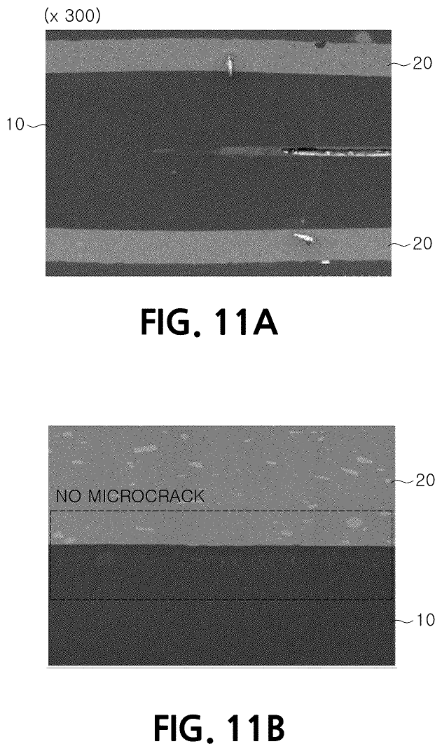

As illustrated in FIG. 7, a sealing material of Inventive Example 1 was folded in half, an electrolyte solution was in contact with a region in which the sealing material was fused, sealing was performed, and then the electrolyte solution was injected to produce 20 sample pouches. The electrolyte solution used was the same as in (1) above, and an insulation resistance measurement method was also the same as in (1). Measured insulation resistances were illustrated in Table 3 in Formation of Water-Repellent Treatment Layer in Fused Region of Inventive Example 1. Furthermore, cross-sections of sample pouches having excellent insulation resistance were subjected to Ar ion milling as described in (1) above and photographed using an SEM, and results therefrom were illustrated in FIGS. 11A and 11B.

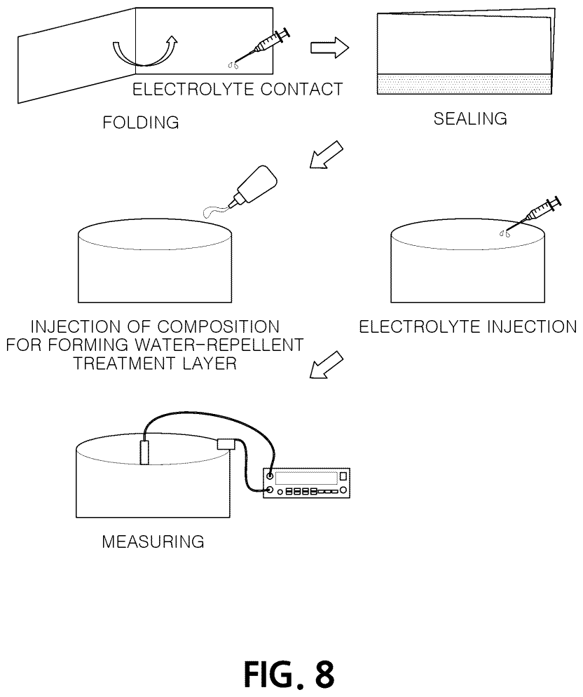

Furthermore, as illustrated in FIG. 8, a sealing material of Comparative Example 1 was folded in half, an electrolyte solution was in contact with a region in which the sealing material was fused, sealing was performed, a composition for forming a water-repellent treatment layer was applied along a peripheral region adjacent to the fused region to be dried at approximately 20 to 25° C. for approximately 60 seconds, and the electrolyte solution was then injected to produce 20 sample pouches. The electrolyte solution used was the same as in (1) above, and an insulation resistance measurement method was also the same as in (1). Measured insulation resistances were illustrated in Table 3 in Formation of Water-Repellent Treatment Layer in

### Peripheral Region of Comparative Example 1.

TABLE 3

| | | |
|---|---|---|
| | Formation of Water- | Formation of Water- |
| | Repellent Treatment | Repellent Treatment |
| | Layer in Fused Region | Layer in Peripheral Region |
| Sample | of Inventive Example 1 | of Comparative Example 1 |

| | |
|---|---|
| No. | Insulation Resistance [MΩ] |

| | | |
|---|---|---|
| 1 | 5000 | 5000 |
| 2 | 5000 | 5000 |
| 3 | 5000 | 5000 |
| 4 | 5000 | 2004 |
| 5 | 5000 | 5000 |
| 6 | 5000 | 3854 |
| 7 | 5000 | 1789 |
| 8 | 5000 | 895 |
| 9 | 5000 | 5000 |
| 10 | 5000 | 5000 |
| 11 | 5000 | 5000 |
| 12 | 5000 | 5000 |
| 13 | 2783 | 5000 |
| 14 | 5000 | 5000 |
| 15 | 5000 | 5000 |
| 16 | 5000 | 5000 |
| 17 | 5000 | 5000 |
| 18 | 5000 | 5000 |
| 19 | 5000 | 5000 |
| 20 | 5000 | 116 |

When the water-repellent treatment layer was formed in the fused region, occurrence of insulation breakdown was lower and a degree of reducing insulation resistance was also lower than when the water-repellent treatment layer was formed only in a peripheral region. Therefore, it was found that formation of the water-repellent treatment layer on both the region in which the sealing material was fused and a surrounding region around the region in which the sealing material was fused may prevent insulation breakdown more effectively than formation of the water-repellent treatment layer only in a peripheral region in which the sealing material was fused. Compared to a case in which the water-repellent treatment layer was not formed (Electrolyte Contact of Comparative Example 1 in Table 1 above), it can be seen that even when the water-repellent treatment layer was formed only in the peripheral region, an effect of preventing insulation breakdown may be present.

FIGS. 11A and 11B illustrate SEM images taken at 300× and 2500× magnifications of cross-sections of sample pouches in which a water-repellent treatment layer was formed in a fused region, in which no insulation breakdown occurred. Compared to portions of FIGS. 10B and 10C, no traces of electrolyte solution vaporization were observed, and no microcracks were formed between the internal resin layer and the metal thin film layer.

A sealing material for a lithium secondary battery and a method for manufacturing the same, according to an embodiment of the present disclosure, may suppress an insulation failure problem that may occur during a process of manufacturing a pouch.

A sealing material for a lithium secondary battery and a method for manufacturing the same, according to an embodiment of the present disclosure, may suppress a formation problem of parasitic capacitance that may occur during a process of manufacturing a pouch.

A pouch cell for a lithium secondary battery according to an embodiment of the present disclosure may have an excellent insulation property.

A pouch cell for a lithium secondary battery according to an embodiment of the present disclosure may prevent an insulation property of a completely sealed pouch from being damaged by an electrolyte solution to be contacted, even when a portion of the electrolyte solution is in contact with an opened portion of the pouch during a degassing process after the pouch is sealed.

A sealing material for a lithium secondary battery, a method for manufacturing the same, and a pouch cell for a lithium secondary battery including the same, of the present disclosure, may be widely applied to green technology fields such as an electric vehicle, a battery charging station, and solar and wind power generation using a battery, or the like, and, furthermore, may be used in an eco-friendly electric vehicle, a hybrid vehicle, or the like to prevent a change in climate by reducing air pollution and greenhouse gas emissions.

Only specific examples of implementations of certain embodiments may be described. Variations, improvements and enhancements of the disclosed embodiments and other embodiments may be made based on the disclosure of this patent document.

### DESCRIPTION OF REFERENCE CHARACTERS

10: Internal resin layer
20: Metal thin film layer
30: Water-repellent treatment layer
40: External resin layer
50: Film layer
60: First adhesive layer
70: Second adhesive layer

What is claimed is:

1. A sealing material for a lithium secondary battery, comprising:
an internal resin layer including a polymer resin;
a metal thin film layer provided on an upper surface of the internal resin layer;
an external resin layer provided on an upper surface of the metal thin film layer;
a film layer provided on an upper surface of the external resin layer; and
a water-repellent treatment layer provided on a lower surface of the internal resin layer.

2. The sealing material of claim 1, wherein the water-repellent treatment layer is provided on at least one region of the lower surface of the internal resin layer, and
wherein the one region is a region in which portions of the sealing material are fused to each other, when the sealing material is folded so that the water-repellent treatment layer is in contact with each other.

3. The sealing material of claim 2, wherein the water-repellent treatment layer is provided in a region in which portions of the sealing material are fused to each other, and a surrounding region thereof.

4. The sealing material of claim 1, wherein the water-repellent treatment layer is formed by chemical treatment or physical treatment.

5. The sealing material of claim 1, wherein the polymer resin is at least one selected from the group consisting of a polypropylene-based polymer resin, a polyethylene-based polymer resin, and a copolymer thereof.

6. The sealing material of claim 1, wherein the metal thin film layer includes aluminum (Al), copper (Cu), iron (Fe), carbon (C), chromium (Cr), manganese (Mn), nickel (Ni), or an alloy of at least two or more thereof.

7. The sealing material of claim 1, further including:
a first adhesive layer provided between the metal thin film layer and the external resin layer; and
a second adhesive layer provided between the external resin layer and the film layer.

8. A pouch cell for a lithium secondary battery, wherein an electrode assembly in which a positive electrode, a negative electrode, and a separator interposed between the positive and negative electrodes are assembled is housed in a pouch sealed with the sealing material of claim 1 such that the water-repellent treatment layer is in contact with each other.

9. A method for manufacturing a sealing material for a lithium secondary battery, comprising:
stacking an internal resin layer including a polymer resin, a metal thin film layer provided on an upper surface of the internal resin layer, an external resin layer provided on an upper surface of the metal thin film layer, and a film layer provided on an upper surface of the external resin layer; and
forming a water-repellent treatment layer provided on a lower surface of the internal resin layer,
wherein the water-repellent treatment layer is formed by chemical treatment or physical treatment.

10. The method of claim 9, wherein the water-repellent treatment layer is provided on at least one region of the lower surface of the internal resin layer, and
wherein the one region is formed by chemical treatment or physical treatment for a region in which portions of the sealing material are fused to each other, or a region in which portions of the sealing material are fused to each other, and a surrounding region thereof, when the sealing material is folded so that the water-repellent treatment layer is in contact with each other.

11. The method of claim 10, wherein the chemical treatment includes applying and drying a composition for forming the water-repellent treatment layer.

12. The method of claim 10, wherein the physical treatment includes forming an etching structure on the lower surface of the internal resin layer at a depth having a micrometer unit level to a nanometer unit level using plasma treatment or laser treatment.
